(19) United States
(12) Patent Application Publication
(10) Pub. No.: US 2021/0362171 A1
(43) Pub. Date: Nov. 25, 2021

(54) Self-rotating spray bar assembly

(71) Applicant: Waterblasting, LLC, Stuart, FL (US)

(72) Inventor: James Crocker, Stuart, FL (US)

(21) Appl. No.: 17/189,945

(22) Filed: Mar. 2, 2021

Related U.S. Application Data
(60) Provisional application No. 62/984,017, filed on Mar. 2, 2020.

(51) Int. Cl. B05B 3/06; B08B 3/02; B05B 13/00

(52) U.S. Cl. CPC B05B 3/06; B08B 3/024; B08B 2203/027; B08B 2203/0264; B05B 13/005

(57) ABSTRACT

A self-rotating device for cleaning with ultra-high water pressure having a base supported by front and rear wheels with a handle extending therefrom. A spray bar assembly with a plurality of nozzles constructed and arranged to cause rotation of the spray bar through fluid discharge is mounted beneath the base. A hydraulic pump is positioned with spray bar and coupled to a reservoir mounted on the handle. The hydraulic pump is rotated by the spray bar assembly, causing hydraulic fluid to recirculate through the reservoir, wherein an adjustable flow valve permits control of the spray bar assembly rotation speed.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/984,017, entitled “SELF-ROTATING SPRAY BAR ASSEMBLY”, filed Mar. 2, 2020; the contents of which are incorporated herein by reference.

### FIELD OF INVENTION

The present invention generally relates to surface cleaning systems, and more particularly, to a self-rotating spray bar assembly, wherein the speed of the spray bar is controlled by water pressure.

### BACKGROUND INFORMATION

Surface cleaning apparatus, such as pressure washers, are useful for cleaning a variety of objects. Although there are many types of pressure washing systems, a typical system utilizes an engine that powers a high pressure pump. The inlet side of the high pressure pump is connected to a low pressure water source, such as a water tank or a municipal water supply, while the high pressure side of the pump is connected to a high pressure hose and wand for controlling the flow of high pressure water for direction against a surface to dislodge dirt, paint and the like. For commercial and industrial applications, the high pressure pumps supply at least 25,000 pounds per square inch (psi), and preferably operate at 40,000 psi. These ultra high pressure systems typically require operation of a large multi-cylinder pump by use of a diesel operated engine. The ultra-high pressure water is directed through piping and/or hoses to various types of spray bars that direct the flow of the pressurized water.

A particular use for ultra-high pressure water devices is the removal of stripes or other markings from road surfaces. When polymers such as paint or plastic are used for roadway marking, the surface of the pavement is penetrated from ⅛-⅜ inch; whereby water blasting is the only known method of removing the stripe material from below the surface without removing a portion of the roadway surface. Ultra-high pressure water pressure washers can also be used to quickly clean surfaces without damaging the surfaces. For instance, road grid can be removed from road markings that might otherwise be obscured due to material deposits left by vehicle tires. Another example would be airport runways, wherein the markings for the touchdown area of the runway can be obscured from the tire deposits left by landing aircraft. Other examples of ultra-high pressure water pressure washers uses include removing paint from ships, cleaning industrial facilities, and removing graffiti.

One common device utilized with surface cleaning devices is the rotary spinner bar. The rotary spinner bar typically includes a tubular member having a central point at which it is connected to a bearing assembly for rotation thereabout. At least one nozzle is secured on each side of a bearing mount. Typically, a motor is connected to the spinner bar to cause rotation thereof about the bearing assembly as pressurized water is directed through the bar and thus the nozzles. Alternatively, the nozzles may be inclined to cause rotation of the associated spinner bar.

As the spinner bar rotates, the high pressure water is directed at the surface to dislodge unwanted particles, paint or the like. A shroud may be positioned around the spinner bar to contain the water and debris, and a vacuum may be attached to the shroud for removing the water and debris from the shroud for containment.

A problem associated with rotary spinner bars is the need for a motor, such as a pneumatic, electrical or independent hydraulic motor, to cause rotation of the spinner bar. Another drawback relates to the speed at which a rotary spinner bar is required to rotate to achieve an acceptable surface cleaning. Most spinner bars rotate at speeds of about 3,000 revolutions per minute, which often results in damage to the spinner bar contacting debris or bumps in the surface.

Therefore, there is a need in the art for a self-rotating device wherein the speed of the spinner bar can be controlled.

### SUMMARY OF THE INVENTION

The present invention relates generally to a walk-behind device that attaches to an ultra-high pressure pump. The ultra-high pressure pump feeds a hydraulic pump and spinner bar containing nozzles. Pressurized water is connected to the device and used to cause rotation of the hydraulic pump which is coupled to a portable hydraulic tank having a valve to control the rotational speed of the spinner bar. The pressurized water further operates the spinner bar by use of an offset position, wherein rotation is a result of reaction force caused by the pressurized water exiting the nozzles mounted on the spinner bar. The hydraulic pump is fluidly coupled to a small hydraulic reservoir mounted on the handle of the device. The hydraulic reservoir includes a hand operated flow valve to control rotational speed of the spinner. The hydraulic pump and reservoir provide uniform speed control and ensure smooth rotation of the spinner bar.

The spray bar works in combination with a mobile pressure cleaning apparatus for cleaning surfaces while minimizing water usage. In the preferred embodiment, the self-rotating device connects to any 40,000 psi pressure pump, and can be configured with either a 10″ or 14″ blasting head using a 15 nozzle spray bar combination. The device is capable of cleaning 500-1,500 square feet per hour with simultaneous vacuum recovery.

Accordingly, it is an objective of the present invention to provide a portable, self-rotating, ultra-high pressure cleaning device.

It is a further objective of the present invention to teach the use of a self-contained hydraulic system on a portable cleaning device.

It is another objective of the present invention to provide a spray bar that is speed adjustable.

Yet another objective of the present invention is to provide an orbital spray bar assembly that does not require separate hydraulic, electrical, or pneumatic power to operate.

Still another objective of the present invention is to teach the use of a spray bar that powers a hydraulic motor, eliminating the potential for imbalance.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a perspective view of the high pressure self-rotating device with a shroud;

FIG. 2 is a perspective view of the high pressure self-rotating device with the shroud removed; and

FIG. 3 is a bottom view of the spray bar.

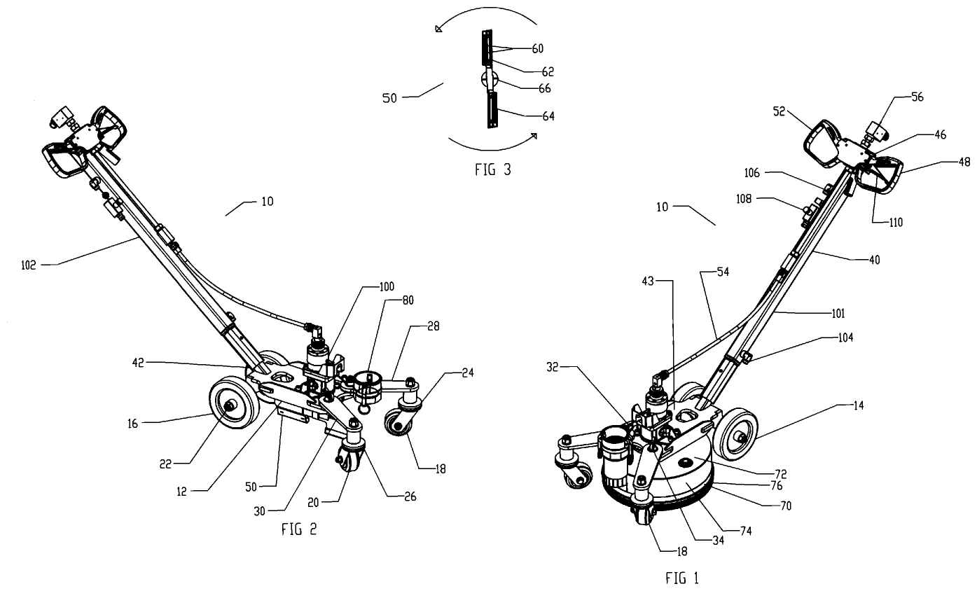

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

Now referring to the figures, illustrated is a self-rotating device 10 for cleaning with ultra-high water pressure, preferably 40,000 psi. The self-rotating device 10 is formed from a base 12 supported by a pair of rear wheels 14, 16 and a pair of front wheels 18, 20. The rear wheels 14, 16 can be mounted on a common axle 22, which allows for straight line tracking. The front wheels 18, 20 are preferably mounted on casters 24, 26, which allow ease of steering by taking weight off the rear wheels. The stance of the base 12 can be further adjusted by positioning of pivot arms 28, 30 using wing nut fasteners 32, 34, thereby allowing different sized spray bars and shrouds using the same base.

A handle 40 has a proximal end 42 secured to an upper surface 43 of the base 12, and a distal end 46 extending outwardly from the base 12 to a convenient position for operator control. The handle preferably has a left grip 48 and a right grip 52 for ease of controlling the cleaning device.

A spray bar assembly 50 is mounted beneath the base 12, employing a conduit 54 that extends from the spray bar assembly 50 to a conduit inlet 56 positioned along the distal end 46 of the handle 40. The spray bar assembly 50 has a plurality of nozzles 60 constructed and arranged in a predetermined pattern to cause rotation of the spray bar upon ultra high pressure water delivered through the nozzles 60; the spray bar assembly 50 having a first nozzle set 62 and second nozzle set 64 offset from the center axis 66. In a preferred embodiment, the spray bar configuration can be configured with either a 10″ (25.4 cm) or 14″ (35.5 cm) spray bar configuration, allowing cleaning capability of 500-1,500 square feet per hour (46.5-139.4 square meters/hr).

A shroud assembly 70 is mounted to a lower surface of the base 12; the shroud assembly 70 being constructed and arranged to enclose a top and sides of the spray bar assembly 50. The shroud assembly 70 is formed from a top wall 72 and a continuous side wall 74 to substantially contain fluid expelled from the plurality of nozzles 60 which are expelling ultra-high pressure water for removal of road surface material. The side wall 74 has a predetermined height that is formed in combination with the front and rear wheels to maintain the spray bar assembly 50 a predetermined distance from the surface being cleaned. A lower edge of the side wall 74 includes a flexible seal 76 or brush material to limit overspray as the device is moved during a cleaning process.

In the preferred embodiment, a vacuum coupling 80 provides an aperture through the shroud assembly 70 for removal of debris. The device is capable of cleaning 500-1,500 square feet per hour (46.5-139.4 square meters/hr) with simultaneous vacuum recovery of at least 800 cubic feet per minute (cfm).

A hydraulic pump 100 is positioned between the conduit inlet 56 and the spray bar assembly 50. The hydraulic pump 100 is coupled to a reservoir 102 mounted on the handle 40. The hydraulic pump 100 is preferably positive displacement and, upon rotation of the spray bar, causes hydraulic fluid to recirculate and to be drawn from a reservoir outlet 104, through the hydraulic pump 100 and return to the reservoir 102 by the reservoir inlet 106. A flow valve 108 is positioned between the reservoir inlet 106 and the hydraulic pump 100. The flow valve 108 is manually modulated to allow the speed of rotation of the spray bar to spin up to 2,500 rpm's. Wherein, when ultra-high pressure water is delivered through the conduit inlet 56, the pressurized fluid causes rotation of the spray bar assembly 50, which is used for cleaning of debris in the path of the spray bar. The rotating spray bar assembly 50 rotates the hydraulic pump 100 for recirculation of hydraulic fluid 101, whereby flow of the hydraulic fluid 101 is adjustable by the flow valve 108 thereby regulating spray bar rotation speed. In one embodiment, the flow valve 108 is a rotatable knob. Lever 110 is used to control the flow of pressurized fluid into the device, providing a means for emergency shut off of fluid and operation of the spinning bar.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A self-rotating device for cleaning with ultra-high water pressure comprising:
a base supported by a pair of rear wheels and a pair of front wheels;
a handle having a proximal end secured to an upper surface of said base and a distal end extending outwardly therefrom;
a spray bar assembly mounted beneath said base, said spray bar assembly including a conduit fluidly coupled to said spray bar and a conduit inlet positioned along the distal end of said handle;
a plurality of nozzles secured to said spray bar assembly and constructed and arranged in a predetermined pattern to cause rotation upon ultra high pressure water delivered through said nozzles;
a shroud assembly mounted to a lower surface of said base, said shroud assembly constructed and arranged to enclose a top and side of said spray bar assembly;
a vacuum coupling providing an aperture through said shroud assembly, said aperture securable to a source of vacuum;
a hydraulic pump positioned between the conduit inlet and said spray bar assembly, said hydraulic pump coupled to a fluid reservoir positioned on said handle, said hydraulic pump rotated by said spray bar assembly, causing hydraulic fluid to recirculate through said reservoir; and
a flow valve positioned between said reservoir and said hydraulic pump;
wherein ultra-high pressure water delivered through said conduit inlet rotating said spray bar assembly for cleaning of debris in the path thereof; said rotating spray bar assembly further rotates said hydraulic pump for recirculation of hydraulic fluid, whereby flow of said hydraulic fluid is adjustable, thereby adjusting spray bar assembly rotation speed.

2. The self-rotating device for cleaning with ultra-high water pressure according to claim 1, wherein said flow valve is adjustable.

3. The self-rotating device for cleaning with ultra-high water pressure according to claim 2, wherein said flow valve is placed in the return line between said hydraulic pump and said reservoir, said flow valve is manually controlled by a pistol grip secured to the distal end of said handle.

4. The self-rotating device for cleaning with ultra-high water pressure according to claim 1, wherein said hydraulic motor is a positive displacement type.

5. The self-rotating device for cleaning with ultra-high water pressure according to claim 1, wherein said shroud assembly is constructed and arranged to substantially contain fluid expelled from said plurality of nozzles.

6. The self-rotating device for cleaning with ultra-high water pressure according to claim 1, wherein said shroud assembly includes a top wall and a side wall.

7. The self-rotating device for cleaning with ultra-high water pressure according to claim 1 wherein said side wall of the shroud has a predetermined height formed in combination with said front and rear wheels to maintain the spray bar assembly a predetermined distance from a surface being cleaned.
